(19) United States
(12) Patent Application Publication
(10) Pub. No.: US 2013/0002403 A1
(43) Pub. Date: Jan. 3, 2013

(54) RFID SYSTEM WITH IMPROVED COVERAGE AND INCREASED READING DISTANCE

(75) Inventor: Allen Minh-Triet Tran, San Diego, CA (US)

(73) Assignee: QUALCOMM INCORPORATED, San Diego, CA (US)

(21) Appl. No.: 13/286,994

(22) Filed: Nov. 1, 2011

Related U.S. Application Data
(60) Provisional application No. 61/503,518, filed on Jun. 30, 2011.

(51) Int. Cl. G06K 7/01

(52) U.S. Cl. 340/10.1

(57) ABSTRACT

A radio frequency identification (RFID) system with a parasitic element to improve coverage and increase reading distance of RFID tags is disclosed. The parasitic element may be a loop of a conductive material and is not physically connected to any circuit. One or more RFID tags may be located within a predetermined distance of the parasitic element. The parasitic element receives a first signal from an RFID reader and re-radiates the first signal. The re-radiation improves the coverage of the RFID system. An RFID tag receives the re-radiated first signal from the parasitic element and, in response, transmits a second signal. The parasitic element receives the second signal from the RFID tag and re-radiates the second signal. The RFID reader receives the re-radiated second signal from the parasitic element and reads the information sent in the second signal by the RFID tag.

### CLAIM OF PRIORITY UNDER 35 U.S.C. §119

The present Application for Patent claims priority to Provisional Application No. 61/503,518, entitled “PARASITICALLY COUPLED ANTENNA” filed Jun. 30, 2011, and assigned to the assignee hereof and hereby expressly incorporated by reference herein.

### BACKGROUND

I. Field

The present disclosure relates generally to electronics, and more specifically to techniques for improving coverage and increasing reading distance of a radio frequency identification (RFID) system.

### II. Background

RFID systems are commonly used to identify and/or track various items such as consumer products. An RFID system typically includes RFID readers and RFID tags. An RFID tag may be attached to an item to be tracked and may include a data storage element and an antenna. The data storage element stores information for the associated item such as a product name, a serial number, product information, a manufacturer, etc. The antenna enables the RFID tag to be read by an RFID reader. Conventionally, the RFID reader needs to be placed in close proximity to the RFID tag in order to read the RFID tag. This requirement of a close reading distance may limit the products and applications for which RFID systems can be used.

### BRIEF DESCRIPTION OF THE DRAWINGS

FIG. 1 shows an RFID system.

FIG. 2 shows a plot of antenna coupling versus distance.

FIG. 3A shows magnetic field strength for an RFID reader.

FIGS. 3B and 3C show magnetic field strength for the RFID reader with a 1-turn parasitic loop.

FIGS. 3D to 3F show magnetic field strength for the RFID reader with a 3-turn parasitic loop.

FIG. 4 shows an RFID system with improved coverage.

FIG. 5 shows another RFID system with improved coverage.

FIG. 6 shows overlapping parasitic loops to improve coverage.

FIG. 7 shows non-overlapping parasitic loops to improve coverage.

FIG. 8 shows a block diagram of an RFID reader and an RFID tag.

FIGS. 9 and 10 show processes for reading an RFID tag.

### DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

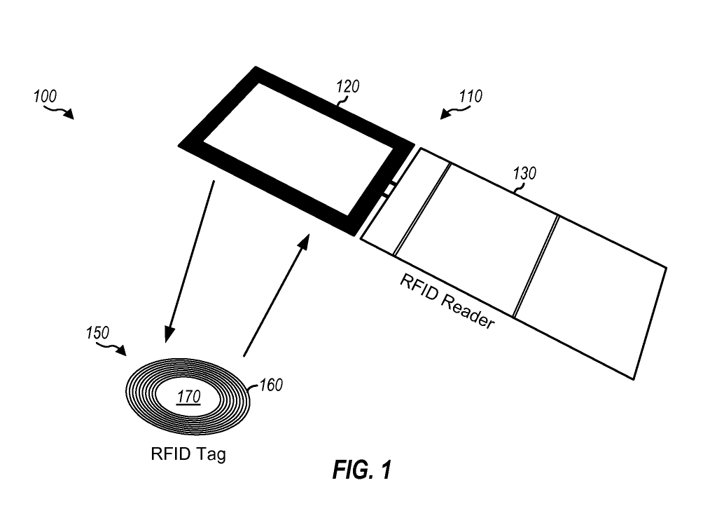

FIG. 1 shows an RFID system 100 that includes an RFID reader 110 and an RFID tag 150. RFID reader 110 may also be referred to as an interrogator, a scanner, etc. RFID tag 150 may also be referred to as an RFID label, an electronics label, etc.

RFID reader 110 includes an antenna 120 and an electronics unit 130. Antenna 120 radiates signals transmitted by RFID reader 110 and receives signals from RFID tags and/or other devices. Electronics unit 130 may include a transmitter and a receiver for reading RFID tags such as RFID tag 150. The same pair of transmitter and receiver (or another pair of transmitter and receiver) may support bi-directional communication with wireless networks, wireless devices, etc. Electronics unit 130 may include processing circuitry (e.g., a processor) to perform processing for data being transmitted and received by RFID reader 110.

RFID tag 150 includes an antenna 160 and a data storage element 170. Antenna 160 radiates signals transmitted by RFID tag 150 and receives signals from RFID reader 110 and/or other devices. Data storage element 170 stores information for RFID tag 150, e.g., in an electrically erasable programmable read-only memory (EEPROM). RFID tag 150 may also include an electronics unit that can process the received signal and generate the signals to be transmitted. RFID tag 150 may be a passive RFID tag having no battery. In this case, a magnetic field from a signal transmitted by RFID reader 110 may induce an electrical current in RFID tag 150, which may then operate based on the induced current. RFID tag 150 can radiate its signal in response to receiving a signal from RFID reader 110 or some other device.

RFID tag 150 may be read as follows. RFID reader 110 may be placed or moved within close proximity to RFID tag 150. RFID reader 110 may radiate a first signal (which is also called an interrogation signal) via its antenna 120. The energy of the first signal may be coupled from RFID reader antenna 120 to RFID tag antenna 160 via magnetic coupling and/or other phenomena. RFID tag 150 may receive the first signal from RFID reader 110 via antenna 160 and, in response, may radiate a second signal (which is also called a responding signal) comprising the information stored in data storage element 170. RFID reader 110 may receive the second signal from RFID tag 150 via antenna 120 and may process the received signal to obtain the information sent in the second signal.

RFID system 100 may be designed to operate at 13.56 MHz or some other frequency. RFID reader 110 may have a specified maximum transmit power level, which may be imposed by the Federal Communication Commission (FCC) in the United Stated or other regulatory bodies in other countries. The specified maximum transmit power level of RFID reader 110 limits the distance at which RFID tag 150 can be read by RFID reader 110.

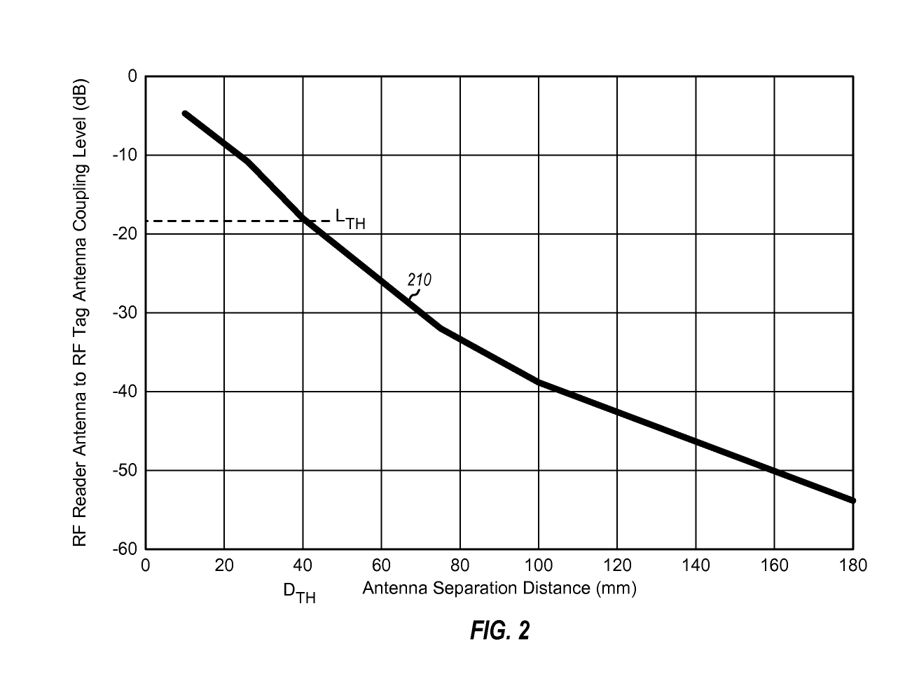

FIG. 2 shows a plot of antenna coupling versus antenna separation distance for RFID system 100 in FIG. 1. The horizontal axis represents the distance between RFID reader antenna 120 and RFID tag antenna 160 in units of millimeter (mm). The vertical axis represents the coupling level, in units of decibel (dB), between RFID reader antenna 120 and RFID tag antenna 160. A plot 210 shows the coupling level between RFID reader antenna 120 and RFID tag antenna 160 versus distance between the two antennas. The coupling level may also be referred to as path loss, attenuation, etc.

As shown in FIG. 2, the coupling level decreases for progressively larger distance between RFID reader antenna 120 and RFID tag antenna 160. A threshold coupling level of L_{TH} or better may be needed to read RFID tag 150. This threshold coupling level may occur at a distance of D_{TH}, which may be referred to as a maximum reading distance. RFID tag 150 may thus be read when RFID reader 110 is placed or moved within a distance of D_{TH} or closer to RFID tag 150.

In the example shown in FIG. 2, the maximum reading distance may be approximately 40 mm. This means that RFID reader 110 needs to be placed within 40 mm of RFID tag 150 in order to read the RFID tag. This short maximum reading distance may limit applications that can use RFID tag 150 and RFID reader 110. In particular, some applications may require RFID tags to be read at distances greater than 40 mm. A greater reading distance may not be possible without increasing the transmit power level of RFID reader 110. However, the transmit power level of RFID reader 110 may be limited by FCC regulations and may not be increased higher.

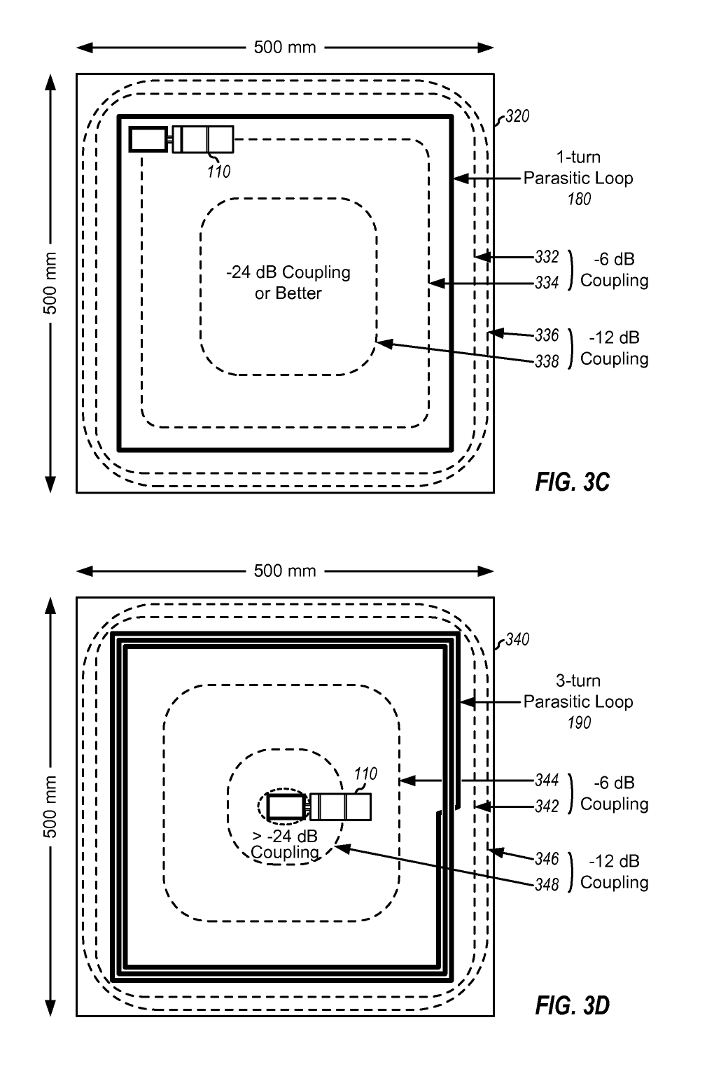

In an aspect, e.g., as shown in FIG. 4 and described in further detail below, a parasitic element may be used to improve coverage and increase the reading distance at which RFID tags can be read. In an exemplary design, the parasitic element may comprise a loop of a conductive material (e.g., a metal) and may be referred to as a parasitic loop. The parasitic element is not physically connected to any circuit (i.e., not physically connected to any RFID tag or any RFID reader) and is not directly applied with any signal. The parasitic element may be located within a predetermined distance of one or more RFID tags. The parasitic element may receive a signal from an RFID reader and may re-radiate the signal toward an RFID tag. The parasitic element may also receive a signal from the RFID tag and may re-radiate the signal toward the RFID reader. The re-radiation may improve the coverage of the RFID system and increase the reading distance of the RFID tag by the RFID reader. For clarity, part of the description below refers to the exemplary design in which the parasitic element is a parasitic loop.

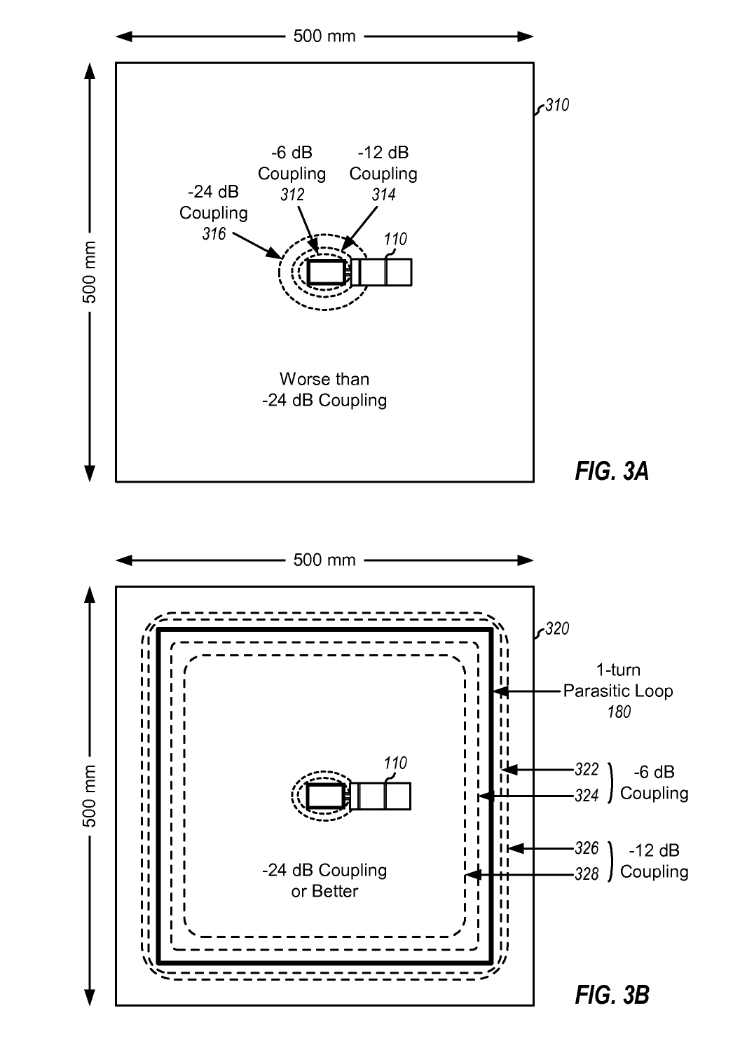

FIG. 3A shows magnetic field strength for RFID reader 110 without a parasitic loop. In FIG. 3A, RFID reader 110 is placed at the center of a square area 310 having a dimension of 500 mm by 500 mm. The strength of the magnetic field was measured at different locations within square area 310 and hence different distances from RFID reader 110. The normalized (or relative) magnetic field strength at each location is determined (in units of dB) relative to a reference magnetic field strength, which is approximately 2 Amperes/meter (A/m). The phrase “magnetic field strength” refers to normalized (or relative) magnetic field strength in much of the description below.

In FIG. 3A, the area within a dashed line 312 observes magnetic field strength of −6 dB or better. The area within a dashed line 314 observes magnetic field strength of −12 dB or better. The area within a dashed line 316 observes magnetic field strength of −24 dB or better. The area outside of dashed line 316 observes magnetic field strength of worse than −24 dB. RFID reader 110 may be able to read an RFID tag located within an area observing magnetic field strength of −24 dB or better. In this case, the coverage of RFID reader 110 may be the area within dashed line 316 and may be limited to a small area surrounding RFID reader 110.

FIG. 3B shows magnetic field strength for RFID reader 110 with a 1-turn parasitic loop 180. In FIG. 3B, parasitic loop 180 is formed near the perimeter or edges of a square area 320 having a dimension of 500 mm by 500 mm. Parasitic loop 180 is not physically connected to any RFID reader or any RFID tag. RFID reader 110 is placed within parasitic loop 180 at the center of square area 320.

In FIG. 3B, the area between dashed lines 322 and 324 observes magnetic field strength of −6 dB or better. The area between dashed lines 326 and 328 observes magnetic field strength of −12 dB or better. The area within dashed line 328 and the area outside of dashed line 326 observe magnetic field strength of −24 dB or better. RFID reader 110 may be able to read an RFID tag located within an area observing magnetic field strength of −24 dB or better. In this case, the coverage of RFID reader 110 may be all or most of square area 320 in FIG. 3B.

FIG. 3C shows magnetic field strength for RFID reader 110 with 1-turn parasitic loop 180. In FIG. 3C, RFID reader 110 is placed near a corner of parasitic loop 180. The area between dashed lines 332 and 334 observes magnetic field strength of −6 dB or better. The area between dashed lines 336 and 338 observes magnetic field strength of −12 dB or better. The area outside of dashed line 336 and the area within dashed line 338 observe magnetic field strength of −24 dB or better. RFID reader 110 may be able to read an RFID tag located anywhere within square area 320. However, the magnetic field strength at most locations within square area 320 is stronger with RFID reader 110 placed near the corner of parasitic loop 180 (as shown in FIG. 3C) than with RFID reader 110 placed at the center of square area 320 (as shown in FIG. 3B).

FIG. 3D shows magnetic field strength for RFID reader 110 with a 3-turn parasitic loop 190. In FIG. 3D, parasitic loop 190 is formed near the edges of a square area 340 having a dimension of 500 mm by 500 mm. The three turns of parasitic loop 190 are non-touching and spiral inward. The end of the outermost turn of parasitic loop 190 is connected to the end of the innermost turn of parasitic loop 190 via an interconnect, which may be formed on another layer. Parasitic loop 190 is not physically connected to RFID reader 110 or any RFID tag. RFID reader 110 is placed within parasitic loop 190 at the center of square area 340.

In FIG. 3D, the area between dashed lines 342 and 344 observes magnetic field strength of −6 dB or better. The area between dashed lines 346 and 348 observes magnetic field strength of −12 dB or better. The area outside of dashed line 346 and the area within dashed line 348 observe magnetic field strength of −24 dB or better. RFID reader 110 may be able to read an RFID tag located anywhere within square area 340. However, the magnetic field strength at most locations within the square area is stronger with 3-turn parasitic loop 190 (as shown in FIG. 3D) than with 1-turn parasitic loop 180 (as shown in FIG. 3B).

FIG. 3E shows magnetic field strength for RFID reader 110 with 3-turn parasitic loop 190. In FIG. 3E, RFID reader 110 is placed near a corner of parasitic loop 190. The area between dashed lines 352 and 354 observes magnetic field strength of 0 dB. The area between dashed lines 356 and 358 observes magnetic field strength of −6 dB or better. The area within dashed line 358 observes magnetic field strength of −9 dB or better. The area outside of dashed line 356 observes magnetic field strength of −24 dB or better. RFID reader 110 may be able to read an RFID tag located anywhere within square area 340. However, the magnetic field strength at most locations within square area 340 is stronger with RFID reader 110 placed near the corner of parasitic loop 190 (as shown in FIG. 3E) than with RFID reader 110 placed at the center of square area 340 (as shown in FIG. 3D).

FIG. 3F shows magnetic field strength for RFID reader 110 with a 3-turn parasitic loop 192 within a square area 360. Parasitic loop 192 has a smaller dimension/size than parasitic loop 190 in FIG. 3E. In FIG. 3F, RFID reader 110 is placed near a corner of parasitic loop 192. The area between dashed lines 362 and 364 observes magnetic field strength of 0 dB. The area within dashed line 364 observes magnetic field strength of −6 dB or better. The area between dashed lines 362 and 366 observes magnetic field strength of −12 dB. The area outside of dashed line 366 observes magnetic field strength of −24 dB or better. RFID reader 110 may be able to read an RFID tag located anywhere within square area 360. However, the magnetic field strength within parasitic loop 192 in FIG. 3F may be stronger than the magnetic field strength within parasitic loop 190 in FIG. 3E.

As shown in FIGS. 3A through 3F, a parasitic loop may receive energy from an antenna of an RFID reader and may re-radiate or redistribute the energy over a larger area to enhance the overall reading area. Because of re-radiation, the magnetic field is stronger over a larger area and especially along the parasitic loop. The re-radiation may improve with more turns in the parasitic loop. In any case, the reading distance with the parasitic loop may be increased substantially (e.g., by five times or more) over the case of no parasitic loop in FIG. 3A.

Various observations may be made based on the performance plots in FIGS. 3A to 3F. First, the use of a parasitic loop may significantly improve the coverage of an RFID system. The improved coverage is clearly shown by the stronger magnetic field strength in FIGS. 3B to 3F relative to FIG. 3A. The improved coverage may allow an RFID tag to be read at a greater distance from an RFID reader, which may be desirable for various applications. The improved coverage may also allow the RFID reader to read more RFID tags, which may be distributed throughout the coverage area of the RFID reader.

Second, the magnetic field strength may be improved by having RFID reader 110 located closer to the parasitic loop. For example, the magnetic field strength is (i) improved in FIG. 3C relative to FIG. 3B for 1-turn parasitic loop 180 and (ii) improved in FIG. 3E relative to FIG. 3D for 3-turn parasitic loop 190. The improved magnetic field strength may be due to stronger reception by the parasitic loop with RFID reader 110 being located closer to the parasitic loop.

Third, a multi-turn parasitic loop may have better coverage than a single-turn parasitic loop. For example, the magnetic field strength is (i) improved for 3-turn parasitic loop 190 in FIG. 3D relative to 1-turn parasitic loop 180 in FIG. 3B and (ii) improved for 3-turn parasitic loop 190 in FIG. 3E relative to 1-turn parasitic loop 180 in FIG. 3C. The improved magnetic field strength may be due to better re-radiation by 3-turn parasitic loop 190 than 1-turn parasitic loop 180.

Fourth, a smaller parasitic loop may have better magnetic field strength within the parasitic loop than a larger parasitic loop. This is shown in FIGS. 3E and 3F. Parasitic loop 192 in FIG. 3F has better magnetic field strength within the parasitic loop than larger parasitic loop 190 in FIG. 3E. The improved magnetic field strength within a smaller parasitic loop is offset by worse magnetic field strength outside of the smaller parasitic loop, as shown in FIGS. 3E and 3F.

FIG. 4 shows an exemplary design of an RFID system 102 with improved coverage. RFID tag 150 may be attached to an item to be tracked and may be located within a predetermined distance of parasitic loop 180. RFID tag 150 may be placed within parasitic loop 180 (as shown in FIG. 4) or outside of parasitic loop 180 (not shown in FIG. 4).

Parasitic element 180 may receive a first signal 112 (or energy) from RFID reader 110 and may re-radiate the first signal. RFID tag 150 may receive a re-radiated first signal 114 from parasitic element 180. In response, RFID tag 150 may transmit a second signal 152. Parasitic element 180 may receive the second signal from RFID tag 150 and may re-radiate the second signal. RFID reader 110 may receive a re-radiated second signal 154 from parasitic element 180 and may process the received signal to recover the information sent by RFID tag 150.

Parasitic loop 180 may be formed on a container or a structure holding an item to which RFID tag 150 is attached. In one exemplary design, RFID tag 150 may be attached to an item that is placed inside a box, and parasitic loop 180 may be formed on the box. As another exemplary design, RFID tag 150 may be attached to an item that is placed on a shelf, and parasitic loop 180 may be formed on or near the shelf. In one exemplary design, parasitic loop 180 may be transportable and may accompany RFID tag 150 wherever the RFID tag is taken. For example, parasitic loop 180 may be formed in the box in the first example described above. In another exemplary design, parasitic loop 180 may be located at a fixed location where RFID tag 150 is expected to be read. For example, parasitic loop 180 may be formed on the shelf in the second example described above.

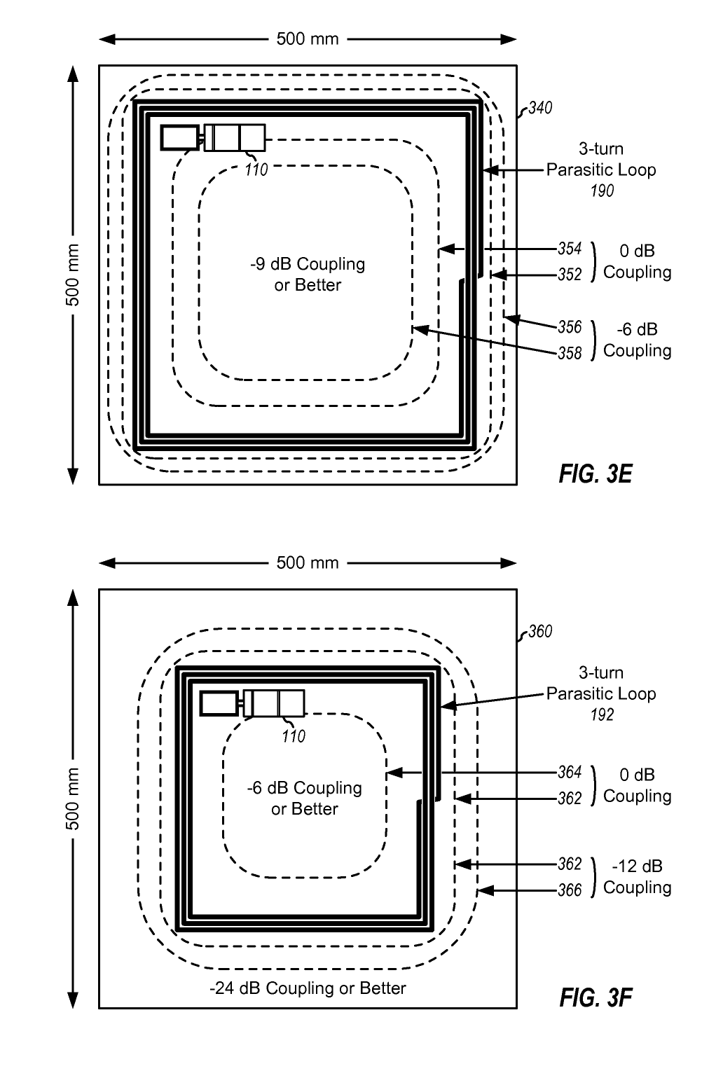

FIG. 5 shows an exemplary design of an RFID system 500 with improved coverage. A set of RFID tags 550a through 550i may be attached to a set of items 520a through 520i to be tracked, one RFID tag 550 on each item 520. Items 520a through 520i may be stored in a box or a container 530. A parasitic loop 580 may be formed on the top of box 530, as shown in FIG. 5. A parasitic loop may also be formed along the sides of box 530 or on the bottom of box 530. Parasitic loop 580 may improve coverage and increase reading distance for RFID tags 550.

FIGS. 3B to 5 show exemplary designs of using a single parasitic loop to improve coverage and increase reading distance. Multiple parasitic loops may also be used to improve coverage and increase reading distance.

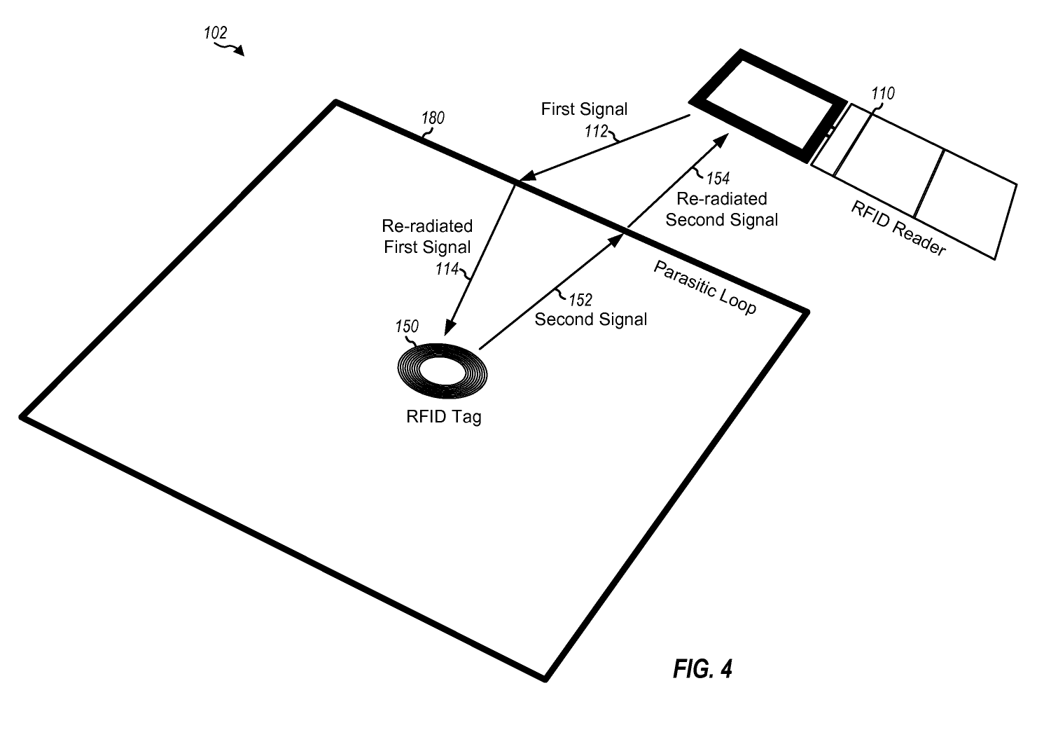

FIG. 6 shows an exemplary design of using two overlapping parasitic loops to improve coverage. In FIG. 6, two parasitic loops 680a and 680b are formed in a square area 620, with inner parasitic loop 680a being formed within outer parasitic loop 680b. The dimension or size of each parasitic loop and the spacing between the parasitic loops may be selected based on the magnetic field strength and the desired coverage, e.g., so that an RFID tag can be placed any where within area 620 and can still be read. Parasitic loops 680a and 680b are not physically connected to any RFID reader or any RFID tag and are not directly applied with any signals.

An RFID tag 650a may be placed within parasitic loop 680a, and an RFID tag 650b may be placed in the area between parasitic loops 680a and 680b. In general, RFID tags may be placed anywhere within a predetermined distance of parasitic loop 680a or 680b. The maximum distance at which an RFID tag may be placed from either parasitic loop 680a or 680b may be dependent on the magnetic field strength measured at different locations.

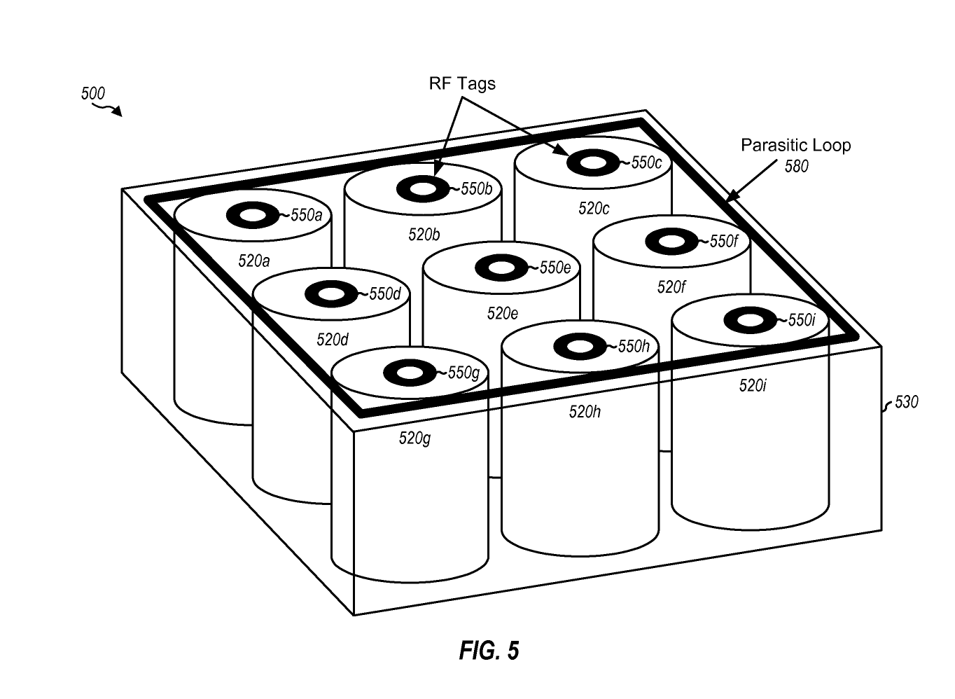

FIG. 7 shows an exemplary design of using non-overlapping parasitic loops to improve coverage. In FIG. 7, four parasitic loops 780a, 780b, 780c and 780d are formed side by side within a square area 720. The dimension of each parasitic loop and the spacing between parasitic loops may be selected based on the magnetic field strength and the desired coverage, e.g., so that an RFID tag can be placed any where within area 720 and can still be read. Parasitic loops 780a to 780d are not physically connected to any RFID reader or any RFID tag and are not directly applied with any signals.

An RFID tag 750a may be placed within parasitic loop 780a, and an RFID tag 750b may be placed in the area between parasitic loops 780a to 780d. In general, RFID tags may be placed anywhere within a predetermined distance of parasitic loop 780a, 780b, 780c or 780d.

Returning to FIG. 5, multiple parasitic loops may be formed on different parts of box 530. For example, one parasitic loop may be formed on the top of box 530 (as shown in FIG. 5), another parasitic loop may be formed on the bottom or sides of block 530, etc.

FIGS. 3B to 7 show exemplary designs of parasitic loops having square or rectangular shapes. Parasitic loops of other shapes may also be used to improve coverage. For example, a parasitic loop may have a shape of a circle, an ellipse, a hexagon, etc. A parasitic loop may also have a shape corresponding to the outline of letter “H,” or “Y”, or “C”, or “E”, etc. The shape and size of a parasitic loop may be selected based on various factors, such as magnetic field strength and expected location of an RFID reader, so that RFID tags placed within a predetermined distance of the parasitic loop can be read. A parasitic element may also be implemented with one or more conductive metal traces each arranged in a straight line.

In an exemplary design, a parasitic element (e.g., a parasitic loop) may be considered as being associated with one or more RFID tags. The parasitic element may be used to improve the coverage and reading distance of the RFID tags and would be present when the RFID tags are read. An RFID reader may be able to read the RFID tags from a greater distance due to the parasitic element. The RFID reader may also be used to read other RFID tags with or without parasitic elements.

In an exemplary design, RFID tags may be attached to items to be tracked (e.g., as shown in FIG. 5) and may be read by passing the RFID tags within the reading distance of RFID readers. In another exemplary design, RFID tags may be attached to items to be tracked, and an RFID reader may be placed near the RFID tags. For example, in FIG. 5, an RFID reader may be attached to box 530 and may be able to read all RFID tags 550 within box 530. The RFID reader may transmit a signal comprising information for RFID tags 550 to a wireless network or a wireless device. This exemplary design may simplify tracking of the entire box 530 of items without requiring an active RFID tag to be attached to each item.

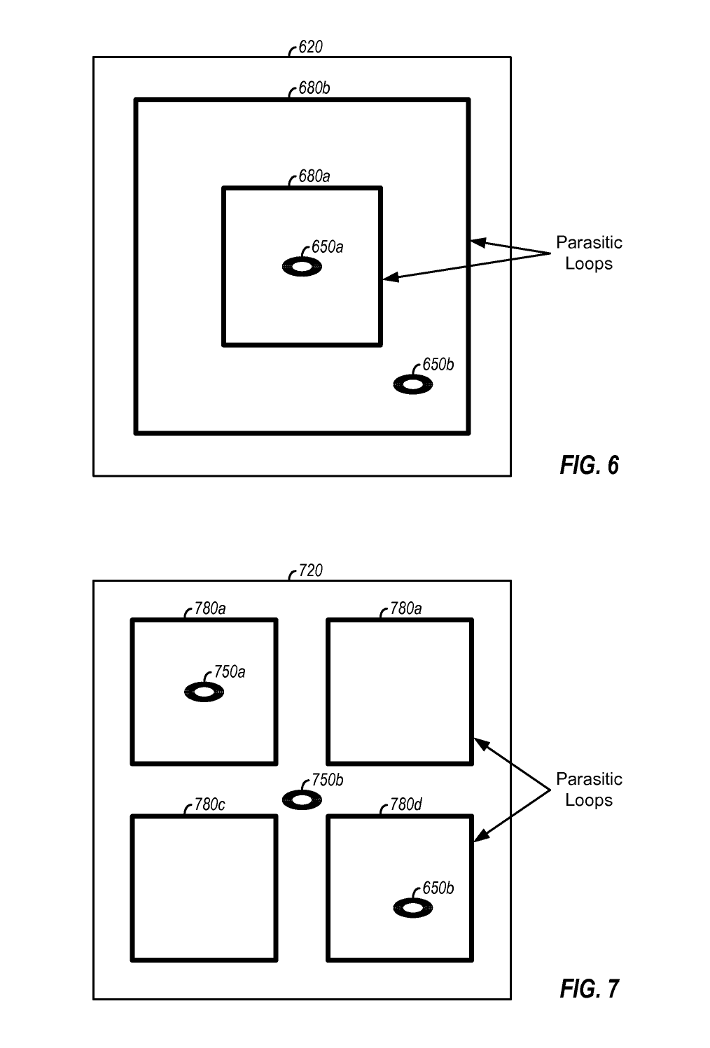

FIG. 8 shows a block diagram of an exemplary design of an RFID reader 810 and an RFID tag 850, which may be any one of the RFID readers and any one of the RFID tags in FIGS. 1 to 7. In the exemplary design shown in FIG. 8, RFID reader 810 includes a data processor/controller 830, a memory 832, a transmitter 834, a receiver 836, and an antenna 820. Transmitter 834 and receiver 836 support reading of RFID tags and further support bi-directional wireless communication.

In the transmit path, data processor 830 processes (e.g., encodes and modulates) data to be transmitted and provides an analog output signal to transmitter 834. Transmitter 834 amplifies, filters, and upconverts the analog output signal from baseband to radio frequency (RF) and provides a modulated signal, which is transmitted via antenna 820 to RFID tags (e.g., via a parasitic element/loop 880) and/or other devices. In the receive path, antenna 820 receives signals from RFID tags (e.g., via parasitic element/loop 880) and/or other devices and provides a received signal to receiver 836. Receiver 836 amplifies, filters, and downconverts the received signal from RF to baseband and provides an analog input signal to data processor 830. Data processor 830 processes the analog input signal to recover information sent by RFID tags and/or other devices. Data processor/controller 830 controls the operation of various units within RFID reader 810. Memory 832 stores program codes and data for data processor/controller 830.

In the exemplary design shown in FIG. 8, RFID tag 850 includes an antenna 860, a receiver 862, a transmitter 864, a data processor/controller 870, and a memory 872. Receiver 862 and transmitter 864 support reading of RFID tag 850. In the receive path, receiver 862 processes a received signal from antenna 860 and provides an analog input signal. Processor 870 processes the analog input signal to obtain information sent by RFID reader 810. In the transmit path, processor 870 provides information to be sent by RFID tag 850 to RFID reader 810. Transmitter 864 processes an analog output signal comprising the information and provides a modulated signal, which is transmitted via antenna 860 and possibly re-radiated by parasitic loop 880 to RFID reader 810. Data processor/controller 870 controls the operation of various units within RFID tag 850. Memory 872 stores program codes and data for data processor/controller 870.

All or a portion of RFID reader 810 may be implemented on one or more integrated circuits (ICs). For example, transmitter 834 and receiver 836 may be implemented on an RF IC (RFIC), and data processor/controller 830 and memory 832 may be implemented on a digital IC. Similarly, all or a portion of RFID tag 850 may be implemented on one or more ICs. For example, receiver 862 and transmitter 864 may be implemented on an RFIC, and data processor/controller 870 and memory 872 may be implemented on a digital IC.

The techniques of using a parasitic element (e.g., a parasitic loop) to improve coverage and increase reading distance of an RFID system may provide various advantages. First, the techniques may increase the reading distance of RFID tags, so that an RFID reader can read the RFID tags from a greater distance. This may be especially desirable for passive RFID tags that do not have internal batteries and hence cannot broadcast their signals. The greater reading distance may be desirable for various applications in which it might be difficult or not possible to have the RFID reader placed close to the RFID tags. Second, the techniques may increase a usable volume for the RFID system. For example, the techniques may enable all RFID tags attached to items contained in a box to be read, as shown in FIG. 5. The techniques may also provide a low cost and low complexity solution to improve coverage. The parasitic element may be readily and economically formed in the vicinity of the RFID tags. The techniques can improve coverage of the RFID system without any modification to the RFID reader and without having to increase the transmit power level of the RFID reader.

In an exemplary design, an RFID system may comprise an RFID tag and a parasitic element. The parasitic element may receive a first signal from an RFID reader and may re-radiate the first signal, e.g., as shown in FIG. 4. The RFID tag may be located within a predetermined distance of the parasitic element and may receive the re-radiated first signal from the parasitic element. The predetermined distance may be a distance that is dependent on the required magnetic field strength, the design of the parasitic element/loop, the placement of the RFID reader, etc.

The RFID tag may transmit a second signal that is re-radiated by the parasitic element. The RFID reader may receive the re-radiated second signal from the parasitic element. The parasitic element may increase a reading distance of the RFID tag by the RFID reader. The parasitic element is not physically connected to the RFID reader or the RFID tag and is not directly applied with any signal.

In an exemplary design, the parasitic element may comprise a loop of conductive material. The loop may have at least one turn, e.g., a single turn as shown in FIGS. 3B and 3C, or a plurality of turns as shown in FIGS. 3D to 3F. The loop may have a shape of a square, a rectangle, a circle, an ellipse, a polygon, etc. The loop may also have a shape of an outline of a character (e.g., “Y”), a symbol, etc. The RFID tag may be located within the loop or outside the loop. The RFID reader may be located within a predetermined range of either the center of the loop (e.g., as shown in FIG. 3B or 3D) or a boundary of the loop (e.g., as shown in FIG. 3C or 3E). In an exemplary design, the RFID reader may transmit the first signal at 13.56 MHz or some other designated frequency. Additional RFID tags may also be located within the predetermined distance of the parasitic element and may be read by the RFID reader via the parasitic element.

In an exemplary design, multiple parasitic elements may be used to improve coverage. For example, a second parasitic element may receive the first signal from the RFID reader and may re-radiate the first signal. The second parasitic element may be placed within the parasitic element (e.g., as shown in FIG. 6) or may be placed side-by-side with the parasitic element (e.g., as shown in FIG. 7). In an exemplary design, multiple parasitic elements may have different orientations, which may provide orientation diversity. For example, the parasitic elements may be orthogonal to one another (e.g., at 90 degrees from each other). In this case, RFID tags may have arbitrary orientations with respect to the parasitic elements.

In an exemplary design, the RFID tag may comprise a passive tag having no internal battery and operating based on magnetic coupling. In an exemplary design, the RFID tag and the parasitic element may be located within a container or box carrying an item to which the RFID tag is attached (e.g., as shown in FIG. 5). The container may or may not include the RFID reader. In another exemplary design, a plurality of RFID tags (which include the RFID tag) may be located within a container and may share the parasitic element. The parasitic element may re-radiate signals for all of the plurality of RFID tags.

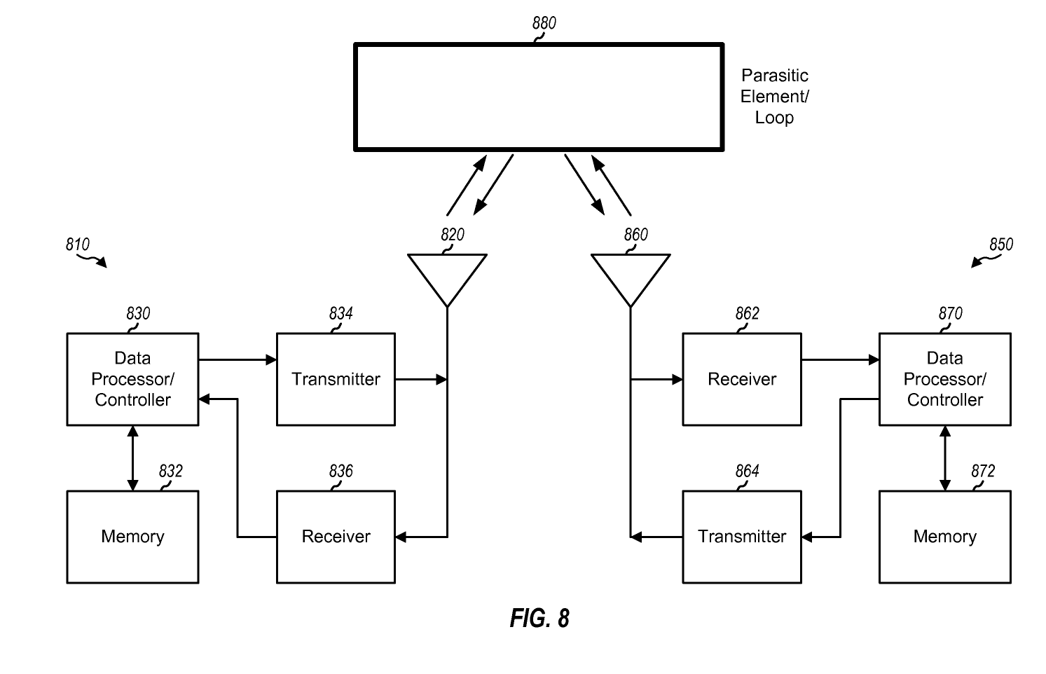

FIG. 9 shows an exemplary design of a process 900 for reading an RFID tag. The RFID tag may receive a first signal transmitted by an RFID reader and re-radiated by a parasitic element (block 912). The RFID tag may transmit a second signal in response to the first signal, with the second signal being re-radiated by the parasitic element (block 914). The RFID reader may receive the re-radiated second signal from the parasitic element. The parasitic element may increase a reading distance of the RFID tag by the RFID reader. In an exemplary design, the parasitic element may comprise a loop of conductive material.

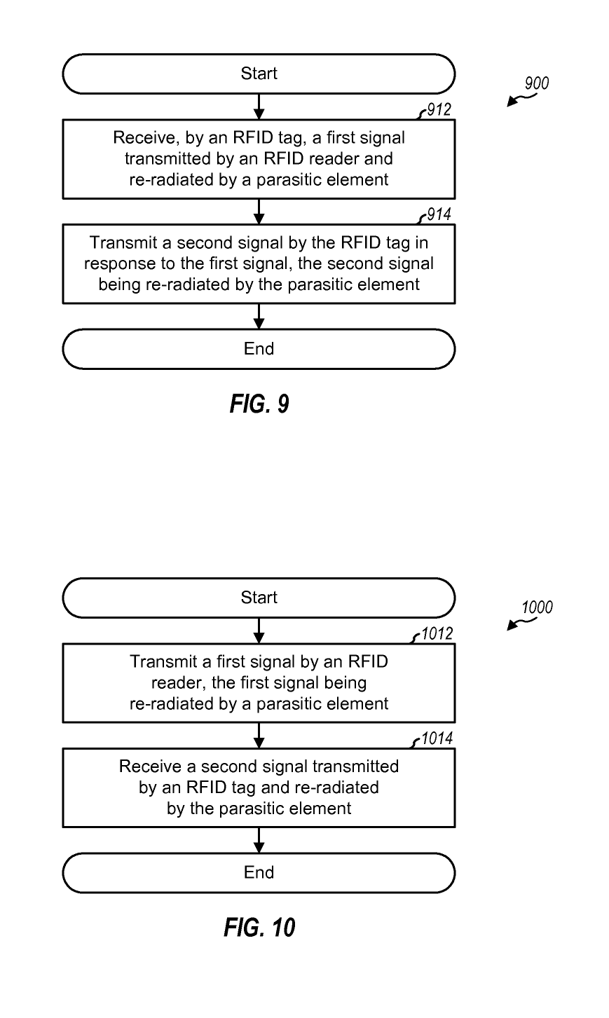

FIG. 10 shows an exemplary design of a process 1000 for reading an RFID tag by an RFID reader. The RFID reader may transmit a first signal, which may be re-radiated by a parasitic element (block 1012). The RFID reader may thereafter receive a second signal transmitted by the RFID tag and re-radiated by the parasitic element (block 1014).

An RFID tag, an RFID reader, and/or a parasitic element described herein may be implemented on an IC, an analog IC, an RFIC, a mixed-signal IC, an application specific integrated circuit (ASIC), a printed circuit board (PCB), an electronic device, etc. An RFID tag and/or an RFID reader may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing an RFID tag and/or an RFID reader described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A radio frequency identification (RFID) system comprising:
a parasitic element configured to receive a first signal from an RFID reader and re-radiate the first signal; and
an RFID tag located within a predetermined distance of the parasitic element and configured to receive the re-radiated first signal from the parasitic element.

2. The RFID system of claim 1, wherein the RFID tag is configured to transmit a second signal that is re-radiated by the parasitic element, and wherein the RFID reader receives the re-radiated second signal from the parasitic element.

3. The RFID system of claim 1, wherein the parasitic element comprises a loop of conductive material.

4. The RFID system of claim 3, wherein the loop comprises at least one turn.

5. The RFID system of claim 3, wherein the RFID tag is located within the loop.

6. The RFID system of claim 3, wherein the loop has a shape of a square, a rectangle, a circle, an ellipse, or a polygon.

7. The RFID system of claim 3, wherein the RFID reader is located within a predetermined range of a center of the loop or a boundary of the loop.

8. The RFID system of claim 1, further comprising:
a second parasitic element configured to receive the first signal from the RFID reader and re-radiate the first signal.

9. The RFID system of claim 8, wherein the parasitic element is placed within the second parasitic element or is placed side-by-side with the second parasitic element.

10. The RFID system of claim 8, wherein the parasitic element and the second parasitic element have different orientations.

11. The RFID system of claim 1, wherein the RFID tag comprises a passive tag operating based on magnetic coupling.

12. The RFID system of claim 1, further comprising:
at least one additional RFID tag located within the predetermined distance of the parasitic element and configured to be read by the RFID reader via the parasitic element.

13. The RFID system of claim 1, wherein the RFID tag and the parasitic element are located within a container carrying an item to which the RFID tag is attached.

14. The RFID system of claim 13, wherein the container further includes the RFID reader.

15. The RFID system of claim 1, further comprising:
a plurality of RFID tags located within a container and sharing the parasitic element, the parasitic element configured to re-radiate signals for the plurality of RFID tags.

16. The RFID system of claim 1, wherein the RFID reader transmits the first signal at 13.56 MHz.

17. The RFID system of claim 1, wherein the parasitic element is not physically connected to the RFID reader or the RFID tag.

18. A method comprising:
receiving, by a radio frequency identification (RFID) tag, a first signal transmitted by an RFID reader and re-radiated by a parasitic element; and
transmitting a second signal by the RFID tag in response to the first signal, the second signal being re-radiated by the parasitic element.

19. The method of claim 18, wherein the parasitic element comprises a loop of conductive material.

20. A method comprising:
transmitting a first signal by a radio frequency identification (RFID) reader, the first signal being re-radiated by a parasitic element; and
receiving a second signal transmitted by an RFID tag and re-radiated by the parasitic element.

21. The method of claim 20, wherein the parasitic element comprises a loop of conductive material.

22. An apparatus comprising:
means for receiving a first signal transmitted by a radio frequency identification (RFID) reader and re-radiated by a parasitic element; and
means for transmitting a second signal in response to the first signal, the second signal being re-radiated by the parasitic element.

23. The apparatus of claim 22, wherein the parasitic element comprises a loop of conductive material.
